(19) United States
(12) Patent Application Publication
(10) Pub. No.: US 2026/0180193 A1
(43) Pub. Date: Jun. 25, 2026

(54) ANTENNA ASSEMBLY

(71) Applicant: Nokia Solutions and Networks Oy, Espoo (FI)

(72) Inventors: Efstratios DOUMANIS, Stuttgart (DE); Murat Emre ERMUTLU, Espoo (FI)

(21) Appl. No.: 19/428,562

(22) Filed: Dec. 22, 2025

(30) Foreign Application Priority Data
Dec. 23, 2024 (FI) 20246540

(51) Int. Cl. H01Q 13/18; H01Q 1/42; H01Q 5/335

(52) U.S. Cl. CPC H01Q 13/18; H01Q 1/42; H01Q 5/335

(57) ABSTRACT

An apparatus, comprising: an antenna radiator configured to be separated from and at least partially overlapping a ground plane; and an antenna feed comprising: at least one cavity resonator configured to convey radio frequency signals, the at least one cavity resonator coupled with a filter probe configured to convey the radio frequency signals between radio circuitry and the at least one cavity resonator, and an antenna coupler configured to couple the radio frequency signals between the at least one cavity resonator and the antenna radiator, the at least one cavity resonator and the antenna coupler being configured to generate filtered radio frequency signals from the radio frequency signals received by the at least one cavity resonator and the antenna coupler.

### TECHNOLOGICAL FIELD

Various example embodiments relate to an antenna assembly.

### BACKGROUND

Antenna assemblies are utilised in various wireless telecommunication networks. Such antenna assemblies are required to conform to various requirements. Although such antenna assemblies exist, they have shortcomings. Accordingly, it is desired to provide an improved antenna assembly.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: an antenna radiator configured to be separated from and at least partially overlapping a ground plane; and an antenna feed comprising: at least one cavity resonator configured to convey radio frequency signals, the at least one cavity resonator coupled with a filter probe configured to convey the radio frequency signals between radio circuitry and the at least one cavity resonator, and an antenna coupler configured to couple the radio frequency signals between the at least one cavity resonator and the antenna radiator, the at least one cavity resonator and the antenna coupler being configured to generate filtered radio frequency signals from the radio frequency signals received by the at least one cavity resonator and the antenna coupler.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

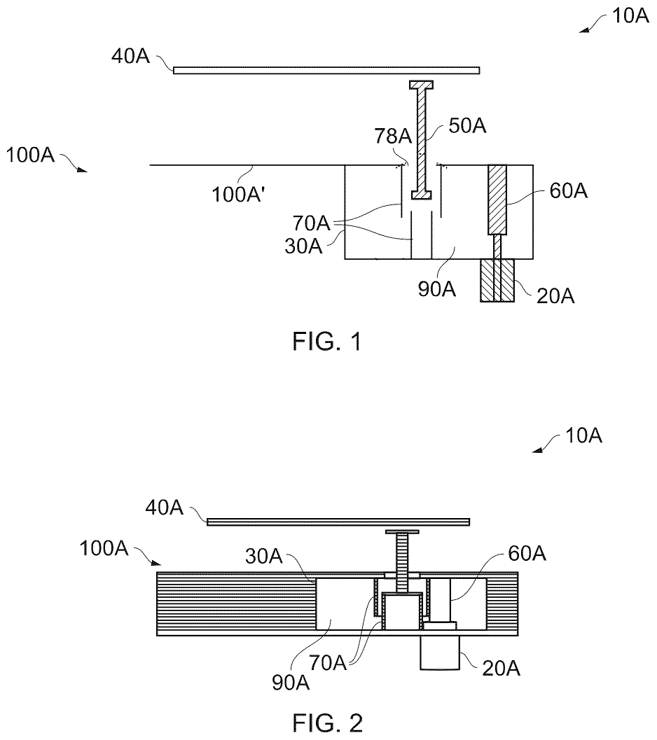

FIG. 1 illustrates schematically a sectional side view of an antenna assembly according to an example embodiment;

FIG. 2 illustrates an example implementation of the arrangement in FIG. 1 according to an example embodiment;

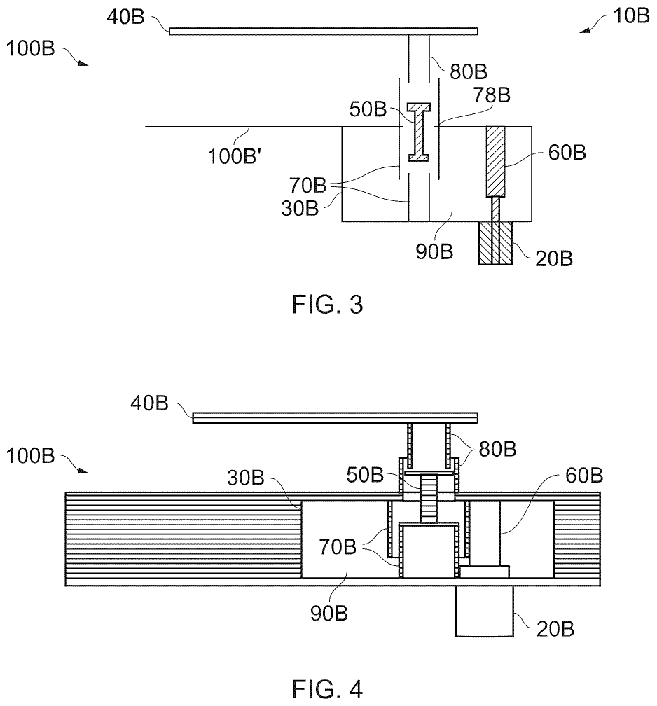

FIG. 3 illustrates schematically a sectional side view of an antenna assembly according to an example embodiment;

FIG. 4 illustrates an example implementation of the arrangement in FIG. 3 according to an example embodiment;

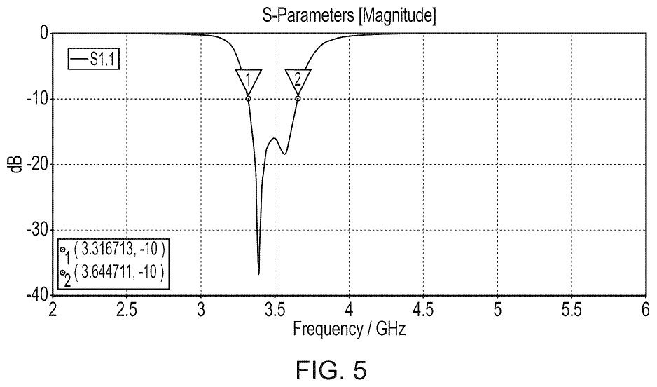

FIG. 5 shows antenna impedance matching vs frequency of the example implementation shown in FIG. 4;

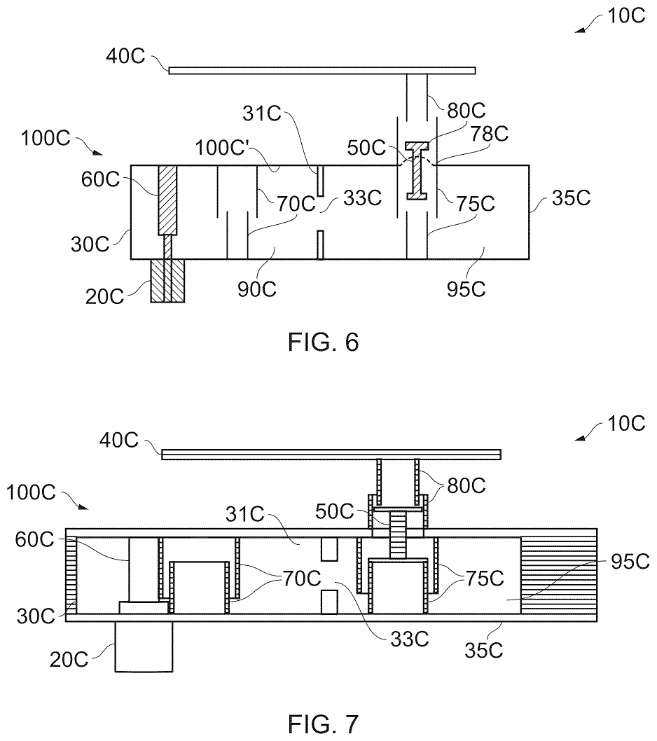

FIG. 6 illustrates schematically a sectional side view of an antenna assembly according to an example embodiment;

FIG. 7 illustrates an example implementation of the arrangement in FIG. 6 according to an example embodiment;

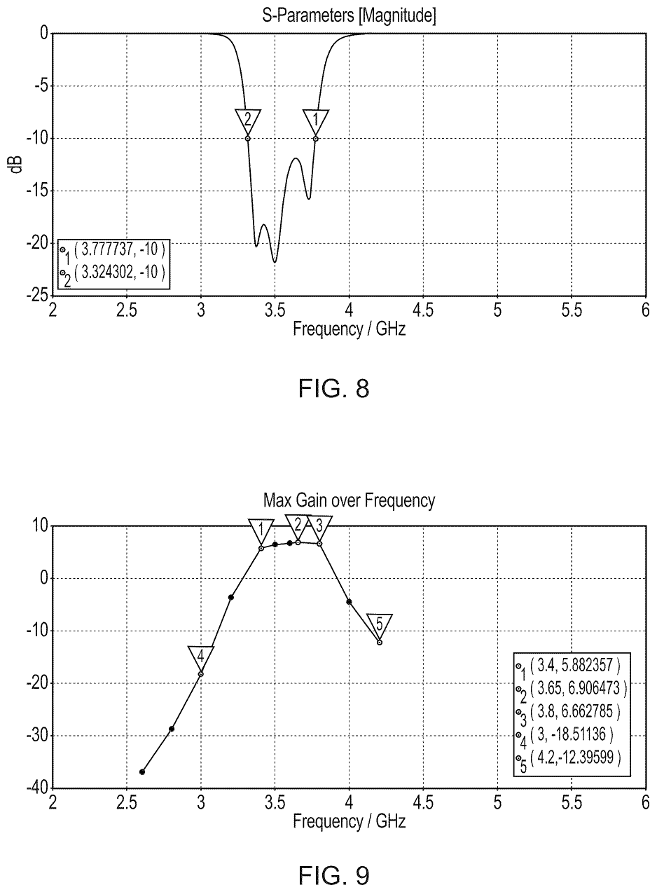

FIG. 8 shows the S-parameters (impedance matching) of the example implementation shown in FIG. 7;

FIG. 9 shows the calculated realized gain of the antenna vs frequency of the example implementation shown in FIG. 7;

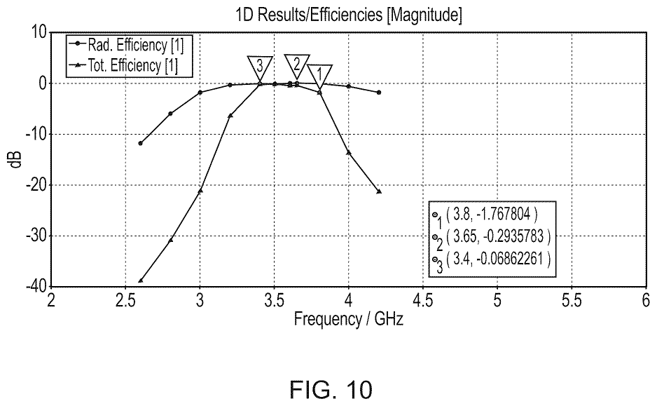

FIG. 10 shows the calculated efficiency of the filtering antenna vs frequency of the example implementation shown in FIG. 7;

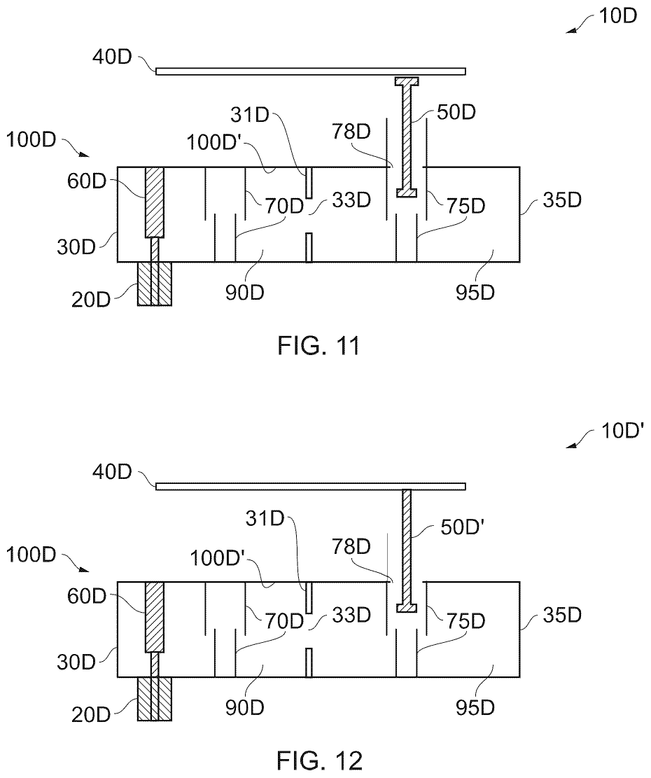

FIGS. 11 and 12 illustrate schematically a sectional side view of an antenna assembly according to example embodiments;

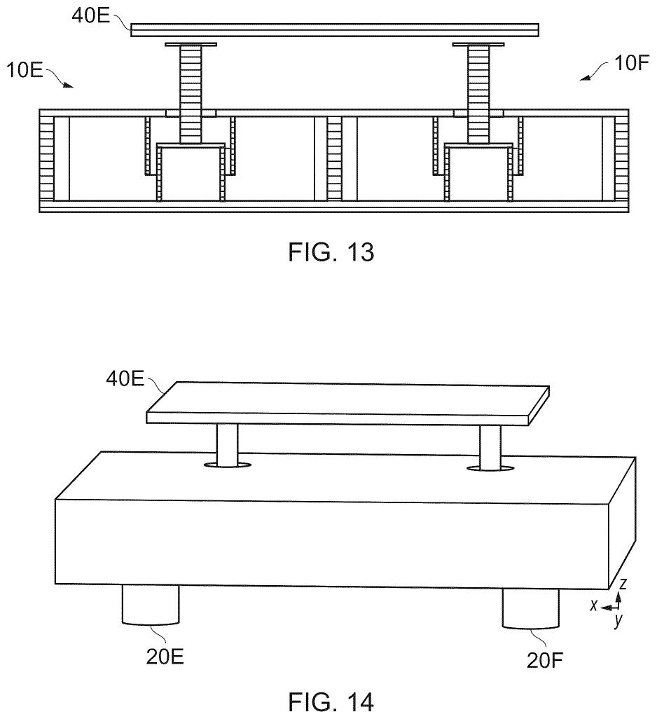

FIGS. 13 and 14 illustrate a partial view of an arrangement where separate antenna assemblies are provided and coupled with a patch antenna to provide for dual-polarisation according to example embodiments;

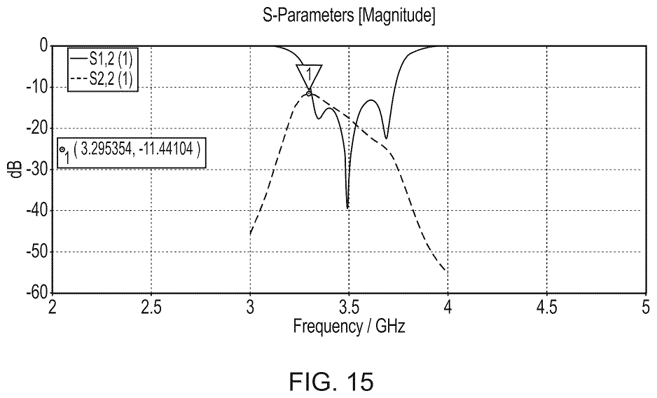

FIG. 15 shows the S-parameters of the example implementation shown in FIGS. 13 and 14.

### DETAILED DESCRIPTION

Before discussing the example embodiments in any more detail, first an overview will be provided. Some example embodiments provide an apparatus having an antenna feed formed from a cavity resonator and an antenna coupler coupled with an antenna radiator as part of a filter. This allows the coupling of the antenna resonance with the filter resonance which helps to extend the bandwidth of the antenna. The cavity resonator may be multiple cavity resonators to add extra reflection zeros in the antenna matching vs frequency response. The antenna feed may also have a resonator to add extra reflection zeros in the antenna matching vs frequency response. The antenna assembly supports one or more polarisation states, with separate filters and couplers and/or resonant feeds coupling with different positions on the same antenna radiator and to provide for the different polarisation states. The apparatus may be provided as part of a network node device such as, for example, an infrastructure device, a base station, a remote radio head (RRH), an infrastructure node, a router, a user equipment and the like.

Antenna elements are used for (Base Transceiver Station) BTS antennas in (multiple input multiple output) MIMO and (massive MIMO) mMIMO (5th generation) 5G and (6th generation) 6G systems. Conventionally, antennas are broadband devices and the filtering of signals occurs at the filter level where the filtering performance implies a superposition of a broadband antenna and a narrow-band filter. In the 5G era, the number of filters required are now a multiple of the number of antennas required. Furthermore, a filter is required per antenna polarization. This signifies the importance of the filtering. Also, the co-location of different and same radio technologies in a tower roof top can lead to interference problems. To minimize the interference in these locations there are some guidelines and requirements for isolation. Furthermore, multi-band antenna systems have similar problems. Under the same enclosure/radome there might be 5 to 6 different antenna bands/systems. This also forces the antenna manufacturer to use simple filtering systems in the feed system to improve the isolation between ports. Some example embodiments seek to overcome bandwidth limitations and limitations of the integration of more resonators into resonant feed antennas. In particular, as mentioned above, in 5G/6G antenna systems a great number of filtering devices are typically required to suppress the frequency interference from other neighbouring systems. By augmenting the frequency properties of the antenna elements, interfering signals can be reduced and filter specifications can be relaxed, improving the overall physical envelope of complicated and costly systems. In massive MIMO systems a filter unit is typically required for each antenna element. With a high number of antenna elements, 32, 64 or 128 elements, the overall cost and physical volume of a great number of filter units impose significant engineering and cost constraints to the 5G systems. Also, in respect of co-site interference, some countries seek to minimize the BTS sites and to make operators use the same tower sites. Therefore, network planning and minimizing the interference between the different systems (2G to 5G), different bands (4G 1800, 3500), or in the same band (for example, for 5G band n78) becomes challenging. Typically, the site construction and network planning units have instructions to improve the isolation, by attaching absorber materials to relevant places, arranging antenna radiation directions, and in very bad cases some filtering is needed for intermodulation problems. Coupling between different antennas in co-location cases depends on: physical spacing of the antennas; radiation patterns; physical construction and mounting of the antennas, including poles, roof materials, etc.; and antenna matching which is also reflected in antenna gain with radiation pattern; for example. each antenna is typically optimised for a particular frequency range and interaction occurs between co-located antennas working in similar frequency ranges. Some example embodiments seek to provide for improved antenna matching. Furthermore, in respect of co-antenna interference, physical space is also a critical infrastructure limitation in antenna hardware (i.e., in a single enclosure) where many cellular systems co-exist. Some antennas have 10 to 12 passive antenna ports and plus 8 to 32 active antenna ports in a single enclosure. This adds extra problems for isolation once many antenna bands/systems are inside the same enclosure. The isolation between these ports is challenging. Antenna manufacturers typically use simple filters to manage the isolation with a cost of reducing the gain of the antenna.

Thus, filtering is the main solution. Those extra filters are typically introduced to the feed network to maximize the isolation between antenna ports.

Some example embodiments extend the antenna structure (probe-fed antenna) with the resonant feed to provide a so-called “filtenna” by integrating the antenna with filter components. This helps to extend the usable/operating bandwidth of the antenna. It improves the limited narrowband operation of the resonant feed antenna. This is achieved by coupling the filter components with the antenna resonance. By integrating the antenna with a filter component and feed, the bandwidth of the filtenna may now be controlled by the filter network.

FIG. 1 illustrates schematically a sectional side view of an antenna assembly 10A according to an example embodiment. FIG. 2 illustrates an example implementation of the arrangement in FIG. 1 according to an example embodiment. This is a probe-fed patch filtenna where the feed is now feeding a resonator cavity filter 30A. The antenna assembly 10A has a multistage filter network comprising the resonator cavity filter 30A having a resonator 70A (a pair of overlapping nested cylinders) within a cavity 90A of the resonator cavity filter 30A and an antenna coupler 50A. The resonator cavity filter 30A is coupled with a connector 20A which couples with radio circuitry (not shown). The connector 20A conveys radio frequency (RF) signals to or from receiver and/or transmitter circuitry of the radio circuitry. In other embodiments, the connector 20A is replaced by other RF transmission lines if further integration, for example, with the receiver and/or transmitter circuitry is required. Such transmission lines may comprise, one or more from: microstrip, stripline, slotline, coplanar waveguide, and microwave tubes. The resonator cavity filter 30A is attached at one side 100A′ of a ground plane 100A. In another embodiment the ground plane 100A extends down the side of the resonator cavity filter 30A to provide at least part of the ground plane further away from an antenna radiator 40A which provides for improvements in bandwidth and/or radiation efficiency of the antenna. There is a metal opening 78A (ground slot) in the ground plane 100A through which the antenna coupler 50A extends to couple between the resonator 70A and the antenna radiator 40A. The metal opening 78A is a non-conductive opening in the ground plane 100A to prevent electrical contact (short-circuit) between the ground plane 100A and the antenna coupler 50A. Although the antenna coupler 50A is configured for capacitive coupling, it will be appreciated that it may instead be configured for galvanic coupling with the antenna radiator 40A. A filter probe 60A (a cylindrical post, although different cross-sections are possible) extends from one side of the cavity 90A towards the opposite side and is galvanically electrically connected to the cavity top wall. The antenna radiator 40A with the antenna coupler 50A and the ground plane 100A form a patch antenna. Hence, it can be seen that both the antenna radiator 40A and the resonator cavity filter 30A share the same ground plane 100A (albeit from different sides).

Although the following description is with respect to driving the antenna radiator 40A to transmit a signal provided via the connector 20A, it will be appreciated that the antenna assembly 10A also works in reverse where the antenna radiator 40A receives a signal and conveys that through the connector 20A via the resonator cavity filter 30A. The connector 20A inputs the signal to the resonator cavity filter 30A. The cavity 90A of the resonator cavity filter 30A is a dielectric-filled cavity comprising metal walls-the physical space provided by the walls of the cavity 90A together with the contained resonant elements constitute a resonator. The dielectric-filled cavity may comprise a dielectric material such as, and not limited to at least one of the following: air; non-conductive materials such as plastic, polystyrene, ceramic; or combinations of non-conductive materials and air. The filter probe 60A receives the signal from the connector 20A and that excites the resonant cavity filter 30A at its natural frequency (fundamental frequency of resonance). Hence, the antenna has a filter feed. The filtered signal provided by the resonator 70A is then coupled with the antenna coupler 50A to the antenna radiator 40A (through the ground slot). The resonant cavity filter 30A and the antenna radiator 40A are positioned back-to-back and are coupled with the antenna coupler 50A. Hence, the antenna feed is a filter network that includes the resonator cavity filter 30A (underneath the ground plane 100A) and the antenna coupler 50A which now acts as an integrated part of the filtenna. This allows the coupling of the antenna resonance with the filter resonance. The antenna operation bandwidth is now controlled by this filter matching network. This is due to coupling of the antenna resonance and the filter resonance. The antenna there has no limitation on the fractional bandwidth. Also, it is possible to extend the bandwidth of the antenna with the resonant feed with more resonators.

The antenna resonates at the frequency of operation of the antenna feed but no longer operates at this frequency range only. The antenna operates now at the coupled bandwidth of the integrated filter network. The antenna resonance is coupled with the filter resonance. That allows to control the operation frequency of the antenna by the parameters of the filter network. This allows to couple the antenna to the filter. This is a unique characteristic of the antenna.

FIG. 3 illustrates schematically a sectional side view of an antenna assembly 10B according to an example embodiment, which is similar to the arrangement set out in FIG. 1 above except that there is also provided a feed resonator 80B. FIG. 4 illustrates an example implementation of the arrangement in FIG. 3 according to an example embodiment. This is a probe-fed patch filtenna where the feed is now feeding a resonator cavity filter 30B and the feed resonator 80B. The antenna assembly 10B has a multistage filter network comprising a resonator cavity filter 30B having a resonator 70B (a pair of overlapping nested cylinders) within a cavity 90B, the feed resonator 80B (a pair of overlapping nested cylinders acting as a resonant feed) and an antenna coupler 50B. The resonator cavity filter 30B is coupled with a connector 20B which couples with radio circuitry (not shown). The connector 20B conveys radio frequency (RF) signals to or from receiver and/or transmitter circuitry of the radio circuitry. In other embodiments, the connector 20B is replaced by other RF transmission lines if further integration, for example, with the receiver and/or transmitter circuitry is required. Such transmission lines may comprise, one or more from: microstrip, stripline, slotline, coplanar waveguide, and microwave tubes. The resonator cavity filter 30B is attached at one side 100B′ of a ground plane 100B. In another embodiment the ground plane 100B extends down the side of the resonator cavity filter 30B to provide at least part of the ground plane further away from an antenna radiator 40B which provides for improvements in bandwidth and/or radiation efficiency of the antenna. There is a metal opening 78B (ground slot) in the ground plane 100B through which the antenna coupler 50B extends to couple between the resonator 70B and the feed resonator 80B. The metal opening 78B is a non-conductive opening in the ground plane 100B to prevent electrical contact (short-circuit) between the ground plane 100B and the antenna coupler 50B. A filter probe 60B (a cylindrical post, although different cross-sections are possible) extends from one side of the cavity 90B towards the opposite side and is connected to the cavity top wall. The antenna radiator 40B with the feed resonator 80B and the ground plane 100B form a patch antenna. Hence, it can be seen that both the antenna radiator 40B and the resonator cavity filter 30B share the same ground plane 100B (albeit from different sides).

Although the following description is with respect to driving the antenna radiator 40B to transmit a signal provided via the connector 20B, it will be appreciated that the antenna assembly 10B also works in reverse where the antenna radiator 40B receives a signal and conveys that through the connector 20B via feed resonator 80B and the resonator cavity filter 30B. The connector 20B inputs the signal to the resonator cavity filter 30B. The cavity 90B of the resonator cavity filter 30B is a dielectric-filled cavity comprising metal walls-the physical space provided by the walls of the cavity 90A together with the contained resonant elements constitute a resonator. The dielectric-filled cavity may comprise a dielectric material such as, and not limited to at least one of the following: air; non-conductive materials such as plastic, polystyrene, ceramic; or combinations of non-conductive materials and air. The filter probe 60B receives the signal from the connector 20B and that excites the resonant cavity filter 30B at its natural frequency (fundamental frequency of resonance). Hence, the antenna has a filter feed. The filtered signal provided by the resonator 70B is then coupled with the antenna coupler 50B to the feed resonator 80B (through the ground slot) which acts as an antenna resonant feed. The resonant cavity 30B and the antenna resonant feed are positioned back-to-back and are coupled with the antenna coupler 50B. Hence, the antenna feed is a filter network that consists of the resonant cavity 30B (underneath the ground plane 100B), the coupling probe 50B (at the ground of the resonant cavity towards the antenna) and the resonant feed (including the feed resonator 80B) which now acts as an integrated part of the filtenna. The antenna coupler 50B and the resonant feed now allow the coupling of the antenna resonance with the filter resonance. The antenna operation bandwidth is now controlled by this filter matching network. This is due to coupling of the antenna resonance and the filter resonance. The antenna there has no limitation on the fractional bandwidth. Also, it is possible to extend the bandwidth of the antenna with the resonant feed with more resonators.

The antenna resonates at the frequency of operation of the resonant feed but no longer operates at this frequency range only. The antenna operates now at the coupled bandwidth of the integrated filter network. The antenna resonance is coupled with the filter resonance. That allows to control the operation frequency of the antenna by the parameters of the filter network and the resonant feed. The resonant feed now forms an intrinsic part of the filter network. This allows to couple the antenna to the filter. This is a unique characteristic of the antenna. To visualize this functionality of the antenna, FIG. 5 shows antenna matching vs frequency where now two reflection zeros occur that represent the resonator resonance and the antenna resonance. It shows the coupling that occurs now between the antenna and the resonator. This allows to control the operation frequency of the antenna which was not possible previously.

FIG. 6 illustrates schematically a sectional side view of an antenna assembly 10B according to an example embodiment, which is similar to the arrangement set out in FIG. 1 above except that there provided a plurality of resonator cavity filters 30C, 35C. FIG. 7 illustrates an example implementation of the arrangement in FIG. 6 according to an example embodiment. This is a probe-fed patch filtenna where the feed is now feeding a pair of resonator cavity filters 30C, 35C and the feed resonator 80C. The antenna assembly 10C has a multistage filter network comprising a first resonator cavity filter 30C having a resonator 70C (a pair of overlapping nested cylinders) within a cavity 90C, a second resonator cavity filter 35C having a resonator 75C (a pair of overlapping nested cylinders) within a cavity 95C, the feed resonator 80C (a pair of overlapping nested cylinders acting as a resonant feed) and an antenna coupler 50C. The first resonator cavity filter 30C is coupled with a connector 20C which couples with radio circuitry (not shown). The connector 20C conveys radio frequency (RF) signals to or from receiver and/or transmitter circuitry of the radio circuitry. In other embodiments, the connector 20C is replaced by other RF transmission lines if further integration, for example, with the receiver and/or transmitter circuitry is required. Such transmission lines may comprise, one or more from: microstrip, stripline, slotline, coplanar waveguide, and microwave tubes. The pair of resonator cavity filters 30C, 35C are attached to one side 100C′ of a ground plane 100C. In another embodiment the ground plane 100C extends down the side of the resonator cavity filter 30C to provide at least part of the ground plane further away from an antenna radiator 40C which provides for improvements in bandwidth and/or radiation efficiency of the antenna. There is a metal opening 78C (ground slot) in the ground plane 100C through which the antenna coupler 50C extends to couple between the resonator 75C and the feed resonator 80C. The metal opening 78C is a non-conductive opening in the ground plane 100C to prevent electrical contact (short-circuit) between the ground plane 100C and the antenna coupler 50C. A filter probe 60C (a cylindrical post, although other cross-sections are possible) extends from one side of the cavity 90C towards the opposite side and is connected to the cavity top wall. The cavity 90C and the cavity 95C are separated by a wall 31C. An aperture 33C in that wall 31C allows for coupling between the pair of resonator cavities 30C, 35C. The aperture 33C controls the amount of coupling between the resonators 70C, 75C. In another example embodiment, no wall is provided and thus the aperture covers the entire surface between the cavities 90C, 95C. The antenna radiator 40C with the feed resonator 80C and the ground plane 100C form a patch antenna. Hence, it can be seen that both the antenna radiator 40C and the resonator cavity filter 30C share the same ground plane 100C (albeit from different sides).

Although the following description is with respect to driving the antenna radiator 40C to transmit a signal provided via the connector 20C, it will be appreciated that the antenna assembly 10C also works in reverse where the antenna radiator 40C receives a signal and conveys that through the connector 20C via the feed resonator 80C and the pair of resonator cavity filters 30C, 35C. The connector 20C inputs the signal to the first resonator cavity filter 30C. The cavity 90C of the first resonator cavity filter 30C and the cavity 95C of the second resonator cavity filter 35C are each a dielectric-filled cavity comprising metal walls-the physical space provided by the walls of the cavity 90C and the cavity 95C together with the contained resonant elements each constitute a resonator. The dielectric-filled cavity may comprise a dielectric material such as, and not limited to at least one of the following: air; non-conductive materials such as plastic, polystyrene, ceramic; or combinations of non-conductive materials and air. The filter probe 60C receives the signal from the connector 20C and that excites the first resonant cavity filter 30C at its natural frequency (fundamental frequency of resonance). The first resonant cavity filter 30C excites the second resonant cavity filter 35C at its natural frequency (fundamental frequency of resonance). Hence, the antenna feed has a filter feed. The filtered signal provided by the resonator 75C is then coupled with the antenna coupler 50C to the feed resonator 80C (through the ground slot) which acts as an antenna resonant feed. The pair of resonator cavities 30C, 35C and the antenna resonant feed are positioned back-to-back and are coupled with the antenna coupler 50C. Hence, the antenna feed is a filter network that consists of the pair of resonator cavities 30C, 35C (underneath the ground plane 100C), the antenna coupler 50C (at the ground of the resonant cavity towards the antenna) and the resonant feed (including the feed resonator 80C) which now acts as an integrated part of the filtenna. The antenna coupler 50C and the resonant feed now allow the coupling of the antenna resonance with the filter resonance. The antenna operation bandwidth is now controlled by this filter matching network. This is due to coupling of the antenna resonance and the filter resonance. The antenna there has no limitation on the fractional bandwidth. Also, it is possible to extend the bandwidth of the antenna with the resonant feed with more resonators.

The antenna resonates at the frequency of operation of the resonant feed but no longer operates at this frequency range only. The antenna operates now at the coupled bandwidth of the integrated filter network. The antenna resonance is coupled with the filter resonance. That allows to control the operation frequency of the antenna by the parameters of the filter network and the resonant feed. The resonant feed now forms an intrinsic part of the filter network. This allows to couple the antenna to the filter. This is a unique characteristic of the antenna. To visualize this functionality of the antenna, FIG. 8 shows the S-parameters of the antenna - the antenna matching vs frequency where now three reflection zeros occur that represent the first and second resonator resonance and the antenna resonance. This graph demonstrates two advantages of this arrangement, the wideband antenna response, and the integration of the antenna with the filter, where the matching of the antenna is controlled by the filtering matching network. FIG. 9 shows the calculated realized gain of the antenna vs frequency. This graph demonstrates the filtering performance of the antenna. The signals outside the antenna band are filtered out by the antenna. A-24 dB reduction of the antenna realized gain is shown from 3.4 GHz towards 3.0 GHz. In 400 MHz, there is an almost 25 dB isolation. FIG. 10 shows the calculated efficiency of the filtering antenna vs frequency. This graph demonstrates that the antenna efficiency is not degraded by the filtering components due to the high-Q of the integrated resonators and relevant high fractional bandwidth.

FIGS. 11 and 12 illustrate schematically a sectional side view of an antenna assembly 10D, 10D′ according to example embodiments, which is similar to the arrangement set out in FIG. 6 except that no resonator is provided and instead an antenna radiator 40D is directly coupled using an antenna coupler 50D. The arrangement of FIG. 11 will now be described—the arrangement of FIG. 12 is identical except that a coupler 50D′ provides for galvanic coupling with the patch antenna 40D. This is a probe-fed patch filtenna where the feed is now feeding a pair of resonator cavity filters 30D, 35D. The antenna assembly 10D has a multistage filter network comprising a first resonator cavity filter 30D having a resonator 70D (a pair of overlapping nested cylinders) within a cavity 90D, a second resonator cavity filter 35D having a resonator 75D (a pair of overlapping nested cylinders) within a cavity 95D and a coupler 50D. The first resonator cavity filter 30D is coupled with a connector 20D which couples with radio circuitry (not shown). The connector 20D conveys radio frequency (RF) signals to or from receiver and/or transmitter circuitry of the radio circuitry. In other embodiments, the connector 20D is replaced by other RF transmission lines if further integration, for example, with the receiver and/or transmitter circuitry is required. Such transmission lines may comprise, one or more from: microstrip, stripline, slotline, coplanar waveguide, and microwave tubes. The pair of resonator cavity filters 30D, 35D are attached to one side 100D′ at the bottom of a ground plane 100D. In another embodiment the ground plane 100D extends down the side of the resonator cavity filter 30D to provide at least part of the ground plane further away from an antenna radiator 40D which provides for improvements in bandwidth and/or radiation efficiency of the antenna. There is a metal opening 78D (ground slot) in the ground plane 100D through which the antenna coupler 50D extends to couple between the resonator 75D and the antenna resonator 40D. The metal opening 78D is a non-conductive opening in the ground plane 100D to prevent electrical contact (short-circuit) between the ground plane 100D and the antenna coupler 50D. A filter probe 60D (a cylindrical post, although other cross-sections are possible) extends from one side of the cavity 90D towards the opposite side and is connected to the cavity top wall. The cavity 90D and the cavity 95D are separated by a wall 31D. An aperture 33D in that wall 31D allows for coupling between the pair of resonator cavities 30D, 35D. The aperture 33D controls the amount of coupling between the resonators 70D, 75D. In another example embodiment, no wall is provided and thus the aperture covers the entire surface between the cavities 90D, 95D. The antenna radiator 40D with the antenna coupler 50D and the ground plane 100D form a patch antenna. Hence, it can be seen that both the antenna radiator 40D and the resonator cavity filters 30D, 90D share the same ground plane 100D (albeit from different sides).

Although the following description is with respect to driving the antenna radiator 40D to transmit a signal provided via the connector 20D, it will be appreciated that the antenna assembly 10D also works in reverse where the antenna radiator 40D receives a signal and conveys that through the connector 20D via the pair of resonator cavity filters 30D, 35D. The connector 20D inputs the signal to the first resonator cavity filter 30D. The cavity 90D of the first resonator cavity filter 30D and the cavity 95D of the second resonator cavity filter 35D are each a dielectric-filled cavity comprising metal walls-the physical space provided by the walls of the cavity 90D and the cavity 95D together with the contained resonant elements each constitute a resonator. The dielectric-filled cavity may comprise a dielectric material such as, and not limited to at least one of the following: air; non-conductive materials such as plastic, polystyrene, ceramic; or combinations of non-conductive materials and air. The filter probe 60D receives the signal from the connector 20D and that excites the first resonant cavity filter 30D at its natural frequency (fundamental frequency of resonance). The first resonant cavity filter 30D excites the second resonant cavity filter 35D at its natural frequency (fundamental frequency of resonance). Hence, the antenna feed has a filter feed. The filtered signal provided by the resonator 75D is then coupled with the antenna coupler 50C to the patch antenna 40D (through the ground slot). The pair of resonator cavities 30C, 35C and the antenna radiator 40D are positioned back-to-back and are coupled with the antenna coupler 50D. Hence, the antenna feed is a filter network that includes the pair of resonator cavities 30D, 35D (underneath the ground plane 100D)and the antenna coupler 50D which now acts as an integrated part of the filtenna. The antenna operation bandwidth is now controlled by this filter matching network. This is due to coupling of the antenna resonance and the filter resonance. The antenna there has no limitation on the fractional bandwidth. Also, it is possible to extend the bandwidth of the antenna with the resonant feed with more resonators.

The antenna resonates at the frequency of operation of the antenna feed but no longer operates at this frequency range only. The antenna operates now at the coupled bandwidth of the integrated filter network. The antenna resonance is coupled with the filter resonance. That allows to control the operation frequency of the antenna by the parameters of the filter network. This allows to couple the antenna to the filter. This is a unique characteristic of the antenna.

FIGS. 13 and 14 illustrate a partial view of an arrangement where separate antenna assemblies 10E, 10F are provided and coupled with an antenna radiator 40E to provide for dual-polarisation. The antenna assemblies 10E, 10F are the antenna assembly described with reference to FIGS. 1 and 2 above but it will be appreciated that they may be any of the antenna assemblies set out above. A signal with a first polarisation is conveyed via the connector 20E provided as part of the antenna assembly 10E and a signal with a second polarisation is conveyed via the connector 20F provided as part of the antenna assembly 10F.

FIG. 15 shows the S-parameters of the antenna—the antenna matching vs frequency and the calculated realized gain of the antenna vs frequency

In some example embodiments, such as the arrangement shown in FIG. 2, the patch antenna 40A typically has dimensions of around 30.5 mm by 30.5 mm. The ground plane 100A typically has dimensions of around 42 mm×42 mm. The resonator cavity filter 30A typically has dimensions of around 20 mm×20 mm×6 mm. The inner cylinder of the pair of overlapping nested cylinders of the resonator 70A typically has a diameter of around 4.8 mm and a height of around 4 mm. The outer cylinder of the pair of overlapping nested cylinders of the resonator 70A typically has a diameter of around 6.4 mm and a height of around 4.3 mm. The coupler 50A typically has a diameter of around 5 mm at the end within the outer cylinder of the pair of overlapping nested cylinders of the resonator 70A, a diameter of around 3.8 mm at the end proximate the antenna radiator 40A and a height of around 7.11 mm. The opening in the ground plane 100A through which the antenna coupler 50A extends is typically around 4.2 mm in diameter. The distance between the end of the antenna coupler 50A and the inner cylinder of the pair of overlapping nested cylinders of the resonator 70A is typically around 0.14 mm. The distance between the end of the antenna coupler 50A and the antenna radiator 40A is typically around 0.55 mm

Hence, in some example embodiments, filter integration is possible. High order filtering/adding more resonators improve the filter response. The feed now couples to a resonator instead of the antenna feed. This couples the antenna resonance with the filter resonance and extends the usable/operating bandwidth of the antenna by adding more reflection zeros which this allows an increase the operation bandwidth more than one can achieve with a single patch element. Such an approach simplifies the antenna, provides higher bandwidth without additional patch element, provides for filter integration and for a filtenna which provides high order filtering, provides for a compact antenna with no need for extra patch element, provides for bandwidth control and for a wider bandwidth and improves the out-of-band isolation for the system since the harmonic outputs of the antenna and the filter are different.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The ordering of method steps set out above may not be critical or fixed and the exact ordering of the steps may be varied as appropriate.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

According to various, but not necessarily all, example embodiments of the invention there is provided an apparatus comprising: an antenna radiator configured to be separated from and at least partially overlapping a ground plane; and an antenna feed comprising: at least one cavity resonator configured to convey radio frequency signals, the at least one cavity resonator coupled with a filter probe configured to convey the radio frequency signals between radio circuitry and the at least one cavity resonator, and an antenna coupler configured to couple the radio frequency signals between the at least one cavity resonator and the antenna radiator, the at least one cavity resonator and the antenna coupler being configured to generate filtered radio frequency signals from the radio frequency signals received by the at least one cavity resonator and the antenna coupler.

The at least one cavity resonator and the antenna coupler may be configured to generate the filtered radio frequency signals to drive the antenna radiator from the radio frequency signals received from the radio circuitry.

The at least one cavity resonator and the antenna coupler maty be configured to generate the filtered radio frequency signals from radio frequency signals received from the antenna radiator and to convey those signals to the radio circuitry.

The antenna coupler may be configured to couple the at least one cavity resonator with resonance of the antenna radiator.

The antenna coupler may extend from the at least one cavity resonator to the antenna radiator and may be configured to provide one of capacitive and galvanic coupling between the antenna coupler and the antenna radiator to covey the filtered radio frequency signals between the antenna coupler and the antenna radiator.

The at least one cavity resonator may comprise a cavity housing a resonator and the antenna coupler may extend between the resonator and the antenna resonator.

The at least one cavity resonator may comprise a cavity housing a filter probe extending into the cavity housing to convey the radio frequency signals between the radio circuitry and the at least one cavity resonator.

The cavity may comprise the ground plane spaced, the filter probe may couple with the ground plane to covey the radio frequency signals between the radio circuitry and the at least one cavity resonator and the resonator may couple with the ground plane.

The coupler may couple with the resonator towards the ground plane.

The resonator may comprise a nested pair of resonator tubes, one of the nested pair of resonator tubes may be coupled with the ground plane and the antenna coupler may couple with the one of the nested pair of resonator tubes coupled with the ground plane.

The antenna feed may comprises a plurality of coupled cavity resonators.

The antenna feed may comprise the plurality of coupled cavity resonators coupled via coupling apertures shared by adjacent cavity resonators.

The antenna feed may comprise a first cavity resonator coupled with a second cavity resonator.

The first cavity resonator may comprise a first cavity housing a first resonator and the filter probe, the second cavity resonator may comprise a second cavity housing a second resonator and the antenna coupler, the first cavity resonator may be coupled with the second cavity resonator via a coupling aperture shared by the first cavity housing and the second cavity housing.

The antenna feed may comprise a feed resonator coupling the at least one cavity resonator with the patch radiator and may be configured to convey the radio frequency signals between the at least one cavity resonator and the antenna radiator.

The antenna coupler may be coupled between the feed resonator and the at least one cavity resonator and may be configured to convey the radio frequency signals between the at least one cavity resonator and the feed resonator.

The feed resonator may extend between the antenna radiator and the ground plane spaced away from the patch antenna.

The feed resonator may be configured to match a resonant frequency of the antenna radiator with a resonant frequency of the at least one cavity resonator.

At least a portion of the at least one cavity resonator may extend from the cavity housing to provide at least a portion of the feed resonator.

The at least one cavity resonator may comprise a cavity housing a nested pair of resonator tubes.

The feed resonator may comprise a nested pair of resonator tubes housed between the antenna radiator and the ground plane.

The antenna feed may be configured to couple a resonance of the antenna radiator with a resonance of the at least one cavity resonator and the feed resonator.

The at least one cavity resonator and the feed resonator may be configured to provide associated antenna matching reflection zeros at offset frequencies.

The apparatus may comprise a plurality of antenna feeds, one for each of a plurality of radio frequency signals and coupled with the antenna radiator to provide for different polarisations.

1. An apparatus, comprising:
an antenna radiator configured to be separated from and at least partially overlapping a ground plane; and
an antenna feed comprising:
at least one cavity resonator configured to convey radio frequency signals,
the at least one cavity resonator coupled with a filter probe configured to convey said radio frequency signals between radio circuitry and the at least one cavity resonator, and
an antenna coupler configured to couple said radio frequency signals between said at least one cavity resonator and the antenna radiator,
said at least one cavity resonator and said antenna coupler being configured to generate filtered radio frequency signals from said radio frequency signals received by said at least one cavity resonator and said antenna coupler.

2. The apparatus of claim 1, wherein said at least one cavity resonator and said antenna coupler is configured to at least one of the following:
generate said filtered radio frequency signals to drive said antenna radiator from said radio frequency signals received from radio circuitry; or
generate said filtered radio frequency signals from radio frequency signals received from said antenna radiator and to convey those signals to said radio circuitry.

3. The apparatus of claim 1, wherein said at least one cavity resonator comprises at least one of the following:
a cavity housing, a resonator and said antenna coupler extends between said resonator and said antenna radiator; or
a cavity housing, said filter probe extending into said cavity housing to convey said radio frequency signals between said radio circuitry and said at least one cavity resonator.

4. The apparatus of claim 3, wherein said cavity comprises said ground plane, said filter probe is configured to couple with said ground plane to convey said radio frequency signals between said radio circuitry and said at least one cavity resonator, and said resonator is configured to couple with said ground plane.

5. The apparatus of claim 4, wherein said resonator comprises a nested pair of resonator tubes, one of said nested pair of resonator tubes being configured to couple with said ground plane and said antenna coupler being configured to couple with said one of said nested pair of resonator tubes coupled with said ground plane.

6. The apparatus of claim 1, wherein said antenna feed comprises at least one of:
a plurality of coupled cavity resonators;
said plurality of coupled cavity resonators coupled via coupling apertures shared by adjacent cavity resonators; or
a first cavity resonator coupled with a second cavity resonator.

7. The apparatus of claim 6, wherein said first cavity resonator comprises a first cavity housing, a first resonator and said filter probe, said second cavity resonator comprises a second cavity housing, a second resonator and said antenna coupler, said first cavity resonator being configured to couple with said second cavity resonator via a coupling aperture shared by said first cavity housing and said second cavity housing.

8. The apparatus of claim 1, wherein said antenna feed comprises a feed resonator coupling said at least one cavity resonator with said antenna radiator and configured to convey said radio frequency signals between said at least one cavity resonator and said antenna radiator.

9. The apparatus of claim 1, wherein said antenna coupler is coupled between said feed resonator and said at least one cavity resonator and configured to convey said radio frequency signals between said at least one cavity resonator and said feed resonator.

10. The apparatus of claim 1, wherein said feed resonator at least one of:
extends between said antenna radiator and said ground plane spaced away from said patch antenna; or
is configured to match a resonant frequency of said antenna radiator with a resonant frequency of said at least one cavity resonator.

11. The apparatus of claim 1, wherein at least a portion of said at least one cavity resonator extends from said cavity housing to provide at least a portion of said feed resonator.

12. The apparatus of claim 1, wherein said at least one cavity resonator comprises a cavity housing a nested pair of resonator tubes.

13. The apparatus of claim 4, wherein said feed resonator comprises a nested pair of resonator tubes housed between said antenna radiator and said ground plane.

14. The apparatus of claim 8, wherein said antenna feed is configured to couple a resonance of said antenna radiator with a resonance of said at least one cavity resonator and said feed resonator.

15. The apparatus of claim 8, wherein said at least one cavity resonator and said feed resonator are configured to provide associated antenna matching reflection zeros at offset frequencies.
